(19) United States
(12) Patent Application Publication
(10) Pub. No.: US 2021/0354669 A1
(43) Pub. Date: Nov. 18, 2021

(54) OPTICAL APPARATUS, IN-VEHICLE SYSTEM, AND MOBILE APPARATUS

(71) Applicant: CANON KABUSHIKI KAISHA, Tokyo (JP)

(72) Inventor: Tomoaki Kawakami, Tochigi (JP)

(21) Appl. No.: 17/308,260

(22) Filed: May 5, 2021

(30) Foreign Application Priority Data
May 18, 2020 (JP) 2020-086574

(51) Int. Cl. B60T 7/12; G01S 17/931; G01S 7/48; B60Q 9/00

(52) U.S. Cl. CPC B60T 7/12; G01S 17/931; B60T 2210/32; B60Q 9/008; G01S 7/4808

(57) ABSTRACT

An optical apparatus includes a deflector configured to deflect illumination light from a light source unit, to scan an object, and to deflect reflected light from the object, a light guide configured to guide the illumination light from the light source unit to the deflector, and to guide reflected light from the deflector to a first light-receiving element, a reflector configured to reflect first light that is part of the illumination light from the deflector, and to reintroduce the first light to the deflector, a filter disposed between the reflector and the first light-receiving element, and configured to transmit light in a specific wavelength band, and a controller configured to determine whether or not an intensity of the first light is included in a specific numerical range, using a signal based on the first light output from the first light-receiving element.

### BACKGROUND OF THE INVENTION

### Field of the Invention

The present invention relates to an optical apparatus that detects the object by receiving light reflected from an illuminated object.

### Description of the Related Art

LIDAR (Light Detection and Ringing) is known as a method for measuring a distance to an object, and calculates the distance from the time for receiving the reflected light from the illuminated object and a phase of the reflected light. Japanese Patent No. 4476599 discloses a configuration that measures a position and distance of an object based on an angle of a deflector (drive mirror) when a light-receiving element receives light reflected from the object and a signal obtained from the light-receiving element.

In a device using LiDAR, noise can be suppressed by disposing a bandpass filter in front of the light-receiving element and by reducing light other than a light source wavelength incident on the light-receiving element. When a device using LiDAR is used in an environment where the temperature significantly changes, the output wavelength of the light source may exceed the specification range of the bandpass filter. In this case, the reflected light from the object cannot pass through the bandpass filter, and a signal indicating that there is no object is acquired.

### SUMMARY OF THE INVENTION

The present invention provides an optical apparatus, an in-vehicle system, and a mobile apparatus, each of which can determine reliability of a signal based on light reflected from an object.

An optical apparatus according to one aspect of the present invention includes a deflector configured to deflect illumination light from a light source unit, to scan an object, and to deflect reflected light from the object, a light guide configured to guide the illumination light from the light source unit to the deflector, and to guide reflected light from the deflector to a first light-receiving element, a reflector configured to reflect first light that is part of the illumination light from the deflector, and to reintroduce the first light to the deflector, a filter disposed between the reflector and the first light-receiving element, and configured to transmit light in a specific wavelength band, and a controller configured to determine whether or not an intensity of the first light is included in a specific numerical range, using a signal based on the first light output from the first light-receiving element.

An in-vehicle system and a mobile apparatus having the above optical apparatus also constitute another aspect of the present invention.

Further features of the present invention will become apparent from the following description of exemplary embodiments with reference to the attached drawings.

### BRIEF DESCRIPTION OF THE DRAWINGS

FIG. 1 is a schematic view of an optical apparatus according to a first embodiment.

FIG. 2 illustrates a center wavelength of a light source light and a change in the center wavelength due to a temperature change.

FIG. 3 illustrates an area provided in a light guide.

FIGS. 4A and 4B illustrate an optical path in the first embodiment.

FIG. 5 illustrates a signal based on reference light and a signal based on reflected light from an object.

FIG. 6 is a schematic view of an optical apparatus according to a second embodiment.

FIG. 7 illustrates a relationship between a magnification varying optical system and a drive mirror.

FIGS. 8A to 8C illustrate an optical path in the second embodiment.

FIG. 9 illustrates a signal based on illumination light from a light source unit, a signal based on reference light, and a signal based on reflected light from an object.

FIG. 10 is a configuration diagram of an in-vehicle system according to this embodiment.

FIG. 11 is a schematic view of a vehicle (mobile apparatus) according to this embodiment.

FIG. 12 is a flowchart showing an operation example of an in-vehicle system according to this embodiment.

### DESCRIPTION OF THE EMBODIMENTS

Referring now to the accompanying drawings, a detailed description will be given of embodiments according to the present invention. Corresponding elements in respective figures will be designated by the same reference numerals, and a duplicate description thereof will be omitted.

An optical apparatus (distance measuring apparatus) using LiDAR includes an illumination system that illuminates an object or target and a light-receiving system that receives reflected light or scattered light from the object. In LiDAR, there are a coaxial system in which parts the optical axes of the illumination system and the light-receiving system coincide with each other, and a non-coaxial system in which the optical axes do not coincide with each other. The optical apparatus according to this embodiment is suitable for coaxial LiDAR.

### First Embodiment

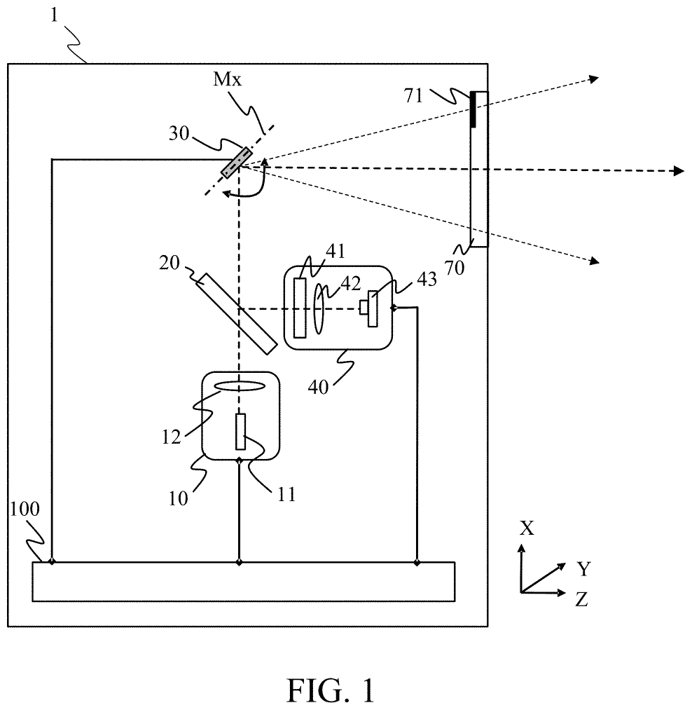

FIG. 1 is a schematic view of the optical apparatus 1 according to this embodiment. The optical apparatus 1 includes a light source unit 10, a light guide (unit) 20, a drive mirror (deflector) 30, a detector 40, and a controller 100.

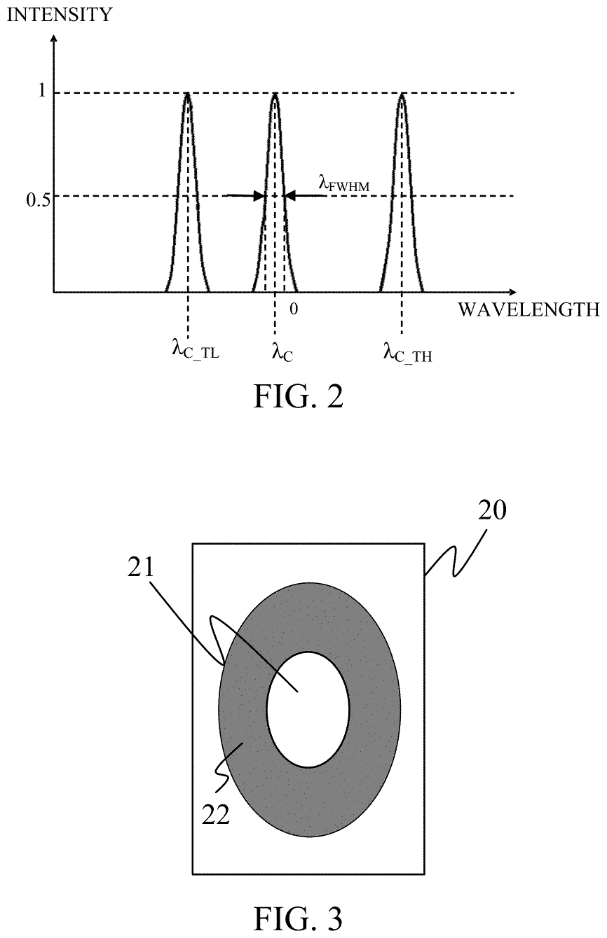

The light source unit 10 includes a light source 11 and a collimator 12 that makes divergent light from the light source 11 substantially collimated (parallel) light. The light emitted from the light source 11 has a wavelength characteristic illustrated in FIG. 2 where is a center wavelength at room temperature (25° C.), λ_{FWHM} is a wavelength width at the intensity of 50%, and the center wavelength is shifted by p (nm/° C.) by temperature. In reality, since the drive circuit is also affected by the temperature change, a light amount emitted from the light source 11 also changes. The wavelength width also slightly changes, but this embodiment normalizes all of them for simplicity purposes. λ_{C_TL} is the center wavelength of the light emitted from the light source 11 at a temperature lower than the room temperature by the temperature TL, and λ_{C_TH} is the center wavelength of the light emitted from the light source 11 at a temperature TH higher than the room temperature.

The light guide 20 is, for example, a perforated mirror, a mirror having a transmission area in a specific range from the center of the optical axis and a reflection area other than the transmission area, a polarization beam splitter, or the like, and guides the illumination light from the light source unit 10 to the drive mirror 30 and the reflected light from the drive mirror 30 to the detector 40.

The light guide 20 includes a flat plate-shaped optical element as illustrated in FIG. 3 in this embodiment. A surface of the light guide 20 on the side of the drive mirror 30 has an area 21 that transmits one part (most) of the illumination light from the light source unit 10 and reflects another part, and an area 22 that reflects the reflected light from the drive mirror 30. When viewed from the side of the light source unit 10, the area 21 is smaller than the effective diameter of the drive mirror 30, and thus the illumination light passing through the area 21 falls within the effective diameter of the drive mirror 30.

In this embodiment, the light guide portion 20 includes a flat plate-shaped optical element, but the present invention is not limited to this example. The light guide 20 may include a polyhedral-shaped optical element (prism) having a plurality of optical surfaces that are not parallel to each other, or a flat plate-shaped optical element and a polyhedral-shaped optical element.

The drive mirror 30 is a two-dimensional scanning drive mirror that is rotatable around each of a Y-axis and an Mx axis indicated by an alternate long and short dash line orthogonal to the Y-axis, which pass through the center of the mirror. The drive mirror 30 deflects the illumination light from the light source unit 10 to scan the object, and the reflected light from the object to guide the light to the light guide 20.

The detector 40 includes a bandpass filter 41, an imaging lens 42, and a light-receiving element (first light-receiving element) 43. The light-receiving element 43 receives light reflected or scattered from the object via the drive mirror 30 and the light guide 20.

The bandpass filter 41 is a filter for transmitting the illumination light having a specific wavelength band from the light source unit 10, but in this embodiment, it transmits light in a wider range than the wavelength width λ_{FWHM} in consideration of the guaranteed temperature. If the wavelength band is made too wide, external light is detected as noise, so that the signal acquired during a detection of a distant object is buried in the noise and cannot be recognized. Therefore, the bandpass filter 41 is configured to transmit only light in the wavelength band necessary to detect the object. A transmission wavelength band λ_{BP} of the bandpass filter 41 satisfies the following conditional expression:

λ_{C}−(Δλ+|T_{L}|×p+λ_{FWHM}/2)≤λ_{BP}≤λ_{C}+(Δλ+|T_{H}|×p+λ_{FWHM}/2)

where T_{L} is a difference between the guaranteed temperature on the low temperature side and normal temperature, T_{H} is a difference between the guaranteed temperature on the high temperature side and the normal temperature, and Δλ is a center wavelength variation due to individual manufacturing error.

In setting the transmission wavelength band λ_{BP} of the bandpass filter 41, a driving circuit and minute wavelength width fluctuations may be taken into account, and 1/e² or the like may be used instead of the wavelength width λ_{FWHM} at the intensity of 50%.

The controller 100 controls a light emission parameter of the light source unit 10, driving of the drive mirror 30, and a light reception parameter of the detector 40.

A window 70 transmits the illumination light from the drive mirror 30. A reflector 71 dims, reflects, and scatters part of the illumination light from the drive mirror 30 at a specific angle of view α and reintroduces it as reference light (first light) into the drive mirror 30.

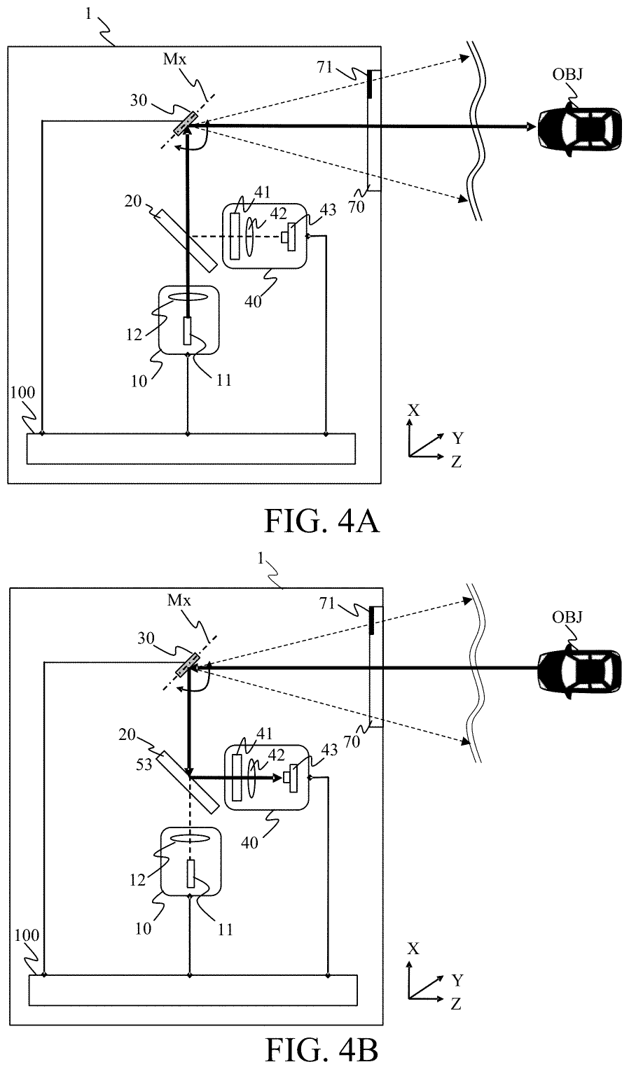

FIGS. 4A and 4B illustrate an optical path according to this embodiment. FIG. 4A illustrates the light beam from the light source unit 10 that passes through the area 21 in the light guide 20 and is reflected and scanned by the drive mirror 30 to illuminate an object OBJ. FIG. 4B illustrates the illumination light from the light source unit 10 that is reflected in the area 21 of the light guide 20 and condensed on the detector 40.

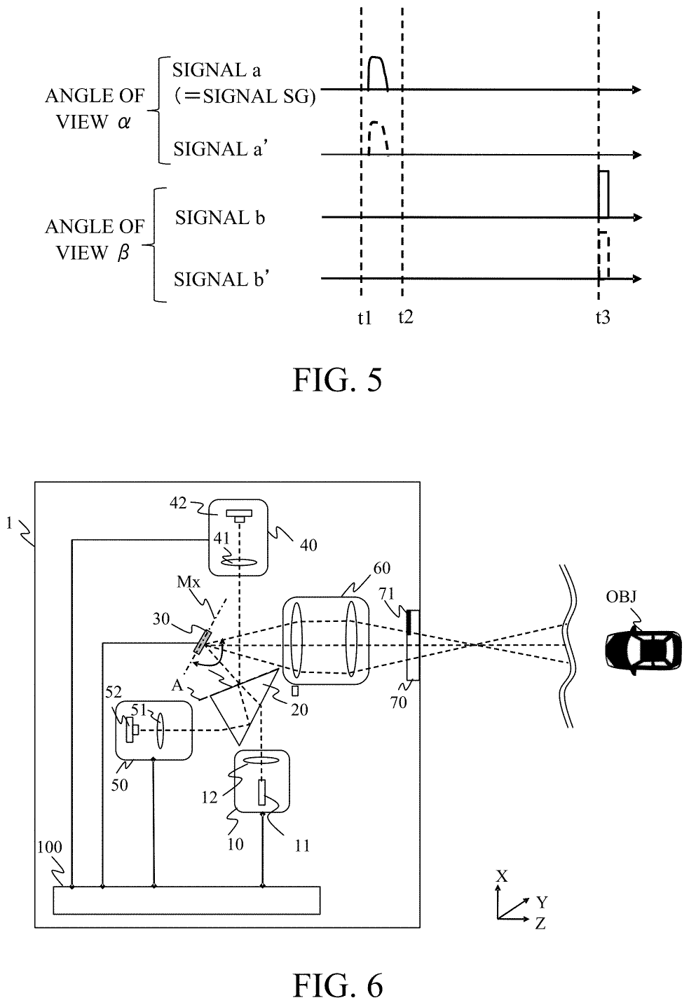

FIG. 5 illustrates a signal SG based on the reference light inside and outside the guaranteed temperature of the bandpass filter 41 and a signal based on the reflected light from the object OBJ. In FIG. 5, the abscissa axis represents time, and the ordinate axis represents a signal intensity. At time t1, the illumination light is emitted from the light source unit 10, and at time t3, the reflected light from the object OBJ is received by the light-receiving element 43.

When the object OBJ is located at an angle of view β different from the angle of view α, the light-receiving element 43 outputs a signal b within the guaranteed temperature. Outside the guaranteed temperature, the wavelength band of the illumination light from the light source unit 10 deviates from the transmission wavelength band of the bandpass filter 41, and the reflected light from the light guide 20 cannot pass through the bandpass filter 41. Therefore, the light-receiving element 43 does not output a signal b′ in FIG. 5, which should be originally output, or outputs a signal weaker than the signal b. In this case, an erroneous determination that there is no object OBJ will be made.

When the object OBJ is located at the angle of view α, the reflector 71 can receive the illumination light, the reference light is generated, and thus the light-receiving element 43 can output a signal SG based on the reference light shown by the signal a in FIG. 5 within the guaranteed temperature. Outside the guaranteed temperature, the light-receiving element 43 does not output the signal a′ in FIG. 5, which should be originally output, or outputs a signal weaker than the signal a.

In this embodiment, the controller 100 determines whether or not the intensity of the reference light falls within a specific numerical range, using the signal SG based on the reference light from when the illumination light is emitted from the light source unit 10 to when the light-receiving element 43 receives the reflected light from the object OBJ. Thereby, the reliability of the signal based on the reflected light from the object OBJ (whether or not the signal based on the reflected light from the object OBJ can be used) can be determined. Whether or not the current temperature falls within the guaranteed temperature range may be determined.

Thus, the signal SG based on the reference light is configured to be output at a specific angle of view, and the reliability of the signal based on the reflected light from the object OBJ output at an angle of view other than the specific angle of view depending on the presence or absence of the signal SG or the intensity change. This configuration can avoid an erroneous determination on the signal based on the reflected light from the object OBJ.

### Second Embodiment

FIG. 6 is a schematic view of an optical apparatus 1 according to this embodiment. The optical apparatus 1 according to this embodiment is different from the optical apparatus 1 of the first embodiment in that the light guide 20 does not have a flat plate shape but is a polyhedral prism including a plurality of optical surfaces that are not parallel to each other, it includes a detector 50, and a magnification varying optical system 60 located on the light emitting side of the drive mirror 30. The magnification varying optical system 60 has no refractive power as a whole (in the overall system), and guides the illumination light from the drive mirror 30 to the object OBJ and the reflected light from the object OBJ to the drive mirror 30. Since other configurations are the same as those in the first embodiment, a detailed description thereof will be omitted.

When the magnification varying optical system 60 is provided, there may be no stray light within the angle of view. For example, the magnification varying optical system 60 has an optical axis eccentric from the center of the drive mirror 30.

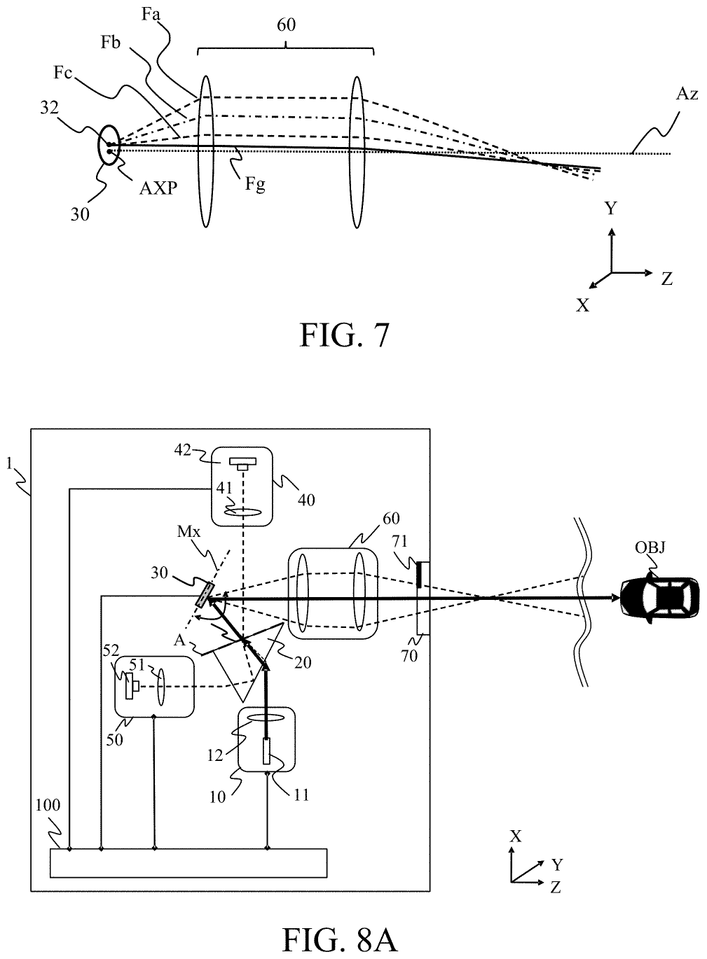

FIG. 7 illustrates a relationship between the magnification varying optical system 60 and the drive mirror 30, and shows a configuration on the light emitting side of the drive mirror 30 in the YZ plane in the configurations of FIG. 6. Fa, Fb, and Fc are an illumination optical path at the outermost angle of view when the drive mirror 30 swings around the Mx axis, an illumination optical path when the swing angle of the drive mirror 30 is 0, and an illumination optical path at the outermost angle of view on the opposite side of the illumination optical path Fa, respectively. The illumination optical path Fc is an illumination optical path at the outermost angle of view used to measure the distance to the object OBJ, and is not an illumination optical path when the drive mirror 30 swings to the maximum. In the range where the drive mirror 30 is tiltable and reflects the light, the illumination optical paths Fa, Fb, and Fc use only one side of the optical axis of the magnification varying optical system 60, and the illumination light is prevented from being vertically entering the optical element of the magnification varying optical system 60. Thereby, the slight reflected light amount generated on the optical element surface does not reach the light-receiving surface of the light-receiving element 43, and thus no stray light occurs.

Fg represents an illumination optical path when the drive mirror 30 has the largest deflection angle relative to the Mx axis. When the illumination optical path Fg vertically enters the optical element of the magnification varying optical system 60, slightly reflected light from the optical element is reflected by the light guide 20 through the same optical path as the illumination optical path Fg and detected as stray light in the detector 40. The angle of view between the illumination optical path Fc and the illumination optical path Fg is a margin for the angle of view at which stray light does not occur. For example, the amount deviated by the manufacturing error is provided as the margin.

FIG. 7 illustrates a state in which the optical axis of the magnification varying optical system 60 and an intersection AXP of the drive mirror 30 are deviated from a center 32 of the drive mirror 30. That is, the optical axis of the magnification varying optical system 60 is eccentric to the center position of the drive mirror 30 or the drive mirror 30 is disposed so that on the deflection surface of the drive mirror 30, the incident point of the principal ray of the illumination light and the optical axis of the magnification varying optical system 60 are separated from each other. Thereby, the stray light from the illumination optical path Fg can also be eccentric. Since it is possible to increase the area where no stray light occurs up to the angle of view outside the illumination optical path Fg, an area on the illumination optical path Fg side of the illumination optical path Fc can be used to measure the distance to the object OBJ. When the illumination optical path Fb is allocated to the illumination optical path Fg side, the illumination optical path Fa can be allocated to the optical axis center side of the magnification varying optical system 60. Then, the effective diameter of the magnification varying optical system 60 can be reduced, and the overall optical apparatus 1 can be made smaller.

As illustrated in FIG. 6, the light guide 20 includes a polygonal optical element in this embodiment. Similar to the light guide 20 of the first embodiment, a surface A of the light guide 20 on the drive mirror 30 side has an area 21 that transmits one part (most) of the illumination light from the light source unit 10, and reflects another part of the illumination light, and an area 22 that reflects the reflected light from the drive mirror 30.

The detector 50 condenses part of the illumination light from the light source unit 10 reflected by the light guide 20 through the imaging lens 51, and measures the light amount at the second light-receiving element 52. The detector 50 may be the same as or different from the detector 40, and may or may not have a bandpass filter, but has a light receivable wavelength band is wider than that of the detector 40.

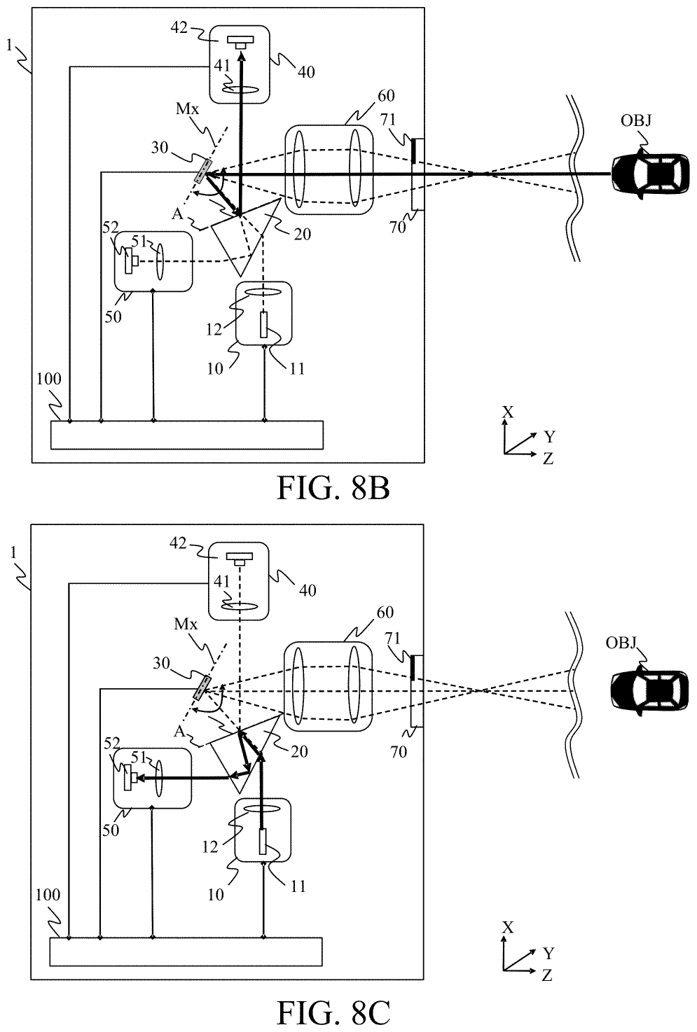

FIGS. 8A to 8C illustrate an optical path in this embodiment. In FIG. 8A, one part of the illumination light from the light source unit 10 enters the light guide 20, is refracted, passes through the area 21 in the light guide 20, is reflected while being scanned by the drive mirror 30, and illuminates the object OBJ. FIG. 8B illustrates the reflected or scattered light from the object OBJ that is reflected by the drive mirror 30, reflected by the area 22 in the light guide 20, and condensed on the detector 40. In FIG. 8C, another part of the illumination light from the light source unit 10 enters the light guide 20 and is refracted, reflected by the area 21 in the light guide 20, and reflected and refracted in the light guide 20, and collected on the detector 50 while changing the direction. Due to this configuration, a diameter of the light beam passing through the light guide 20 in this embodiment is reduced or expanded on the XZ plane, while its divergence angle is expanded or reduced.

The detector 40 receives the reflected light from the object OBJ, which changes depending on the wavelength and angle of view of the light emitted from the light source unit 10. The detector 50 receives the illumination light from the light source unit 10 that does not depend on the object OBJ or the angle of view.

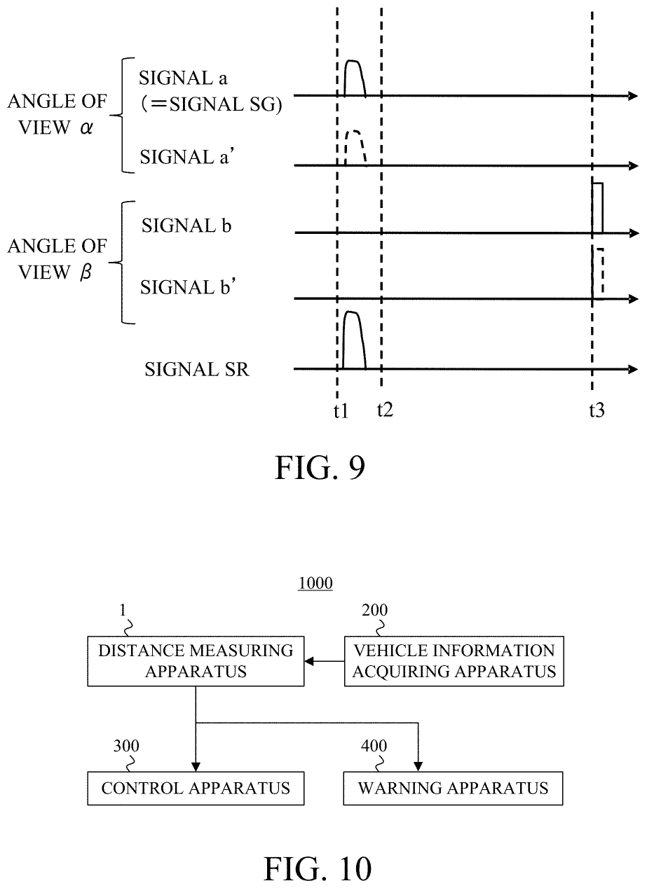

FIG. 9 illustrates a signal SR based on the illumination light from the light source unit 10 inside and outside the guaranteed temperature of the bandpass filter 41, a signal SG based on the reference light, and a signal based on the reflected light from the object OBJ. In FIG. 9, the abscissa axis represents time and the ordinate axis represents a signal intensity.

Within the guaranteed temperature, when the object OBJ is located at an angle of view β different from the angle of view α, the light-receiving element 43 outputs the signal b. When the object OBJ is located at the angle of view α, the light-receiving element 52 outputs a signal SG based on the reference light indicated by the signal a.

Outside the guaranteed temperature, when the object OBJ is located at the angle of view β, the light-receiving element 43 does not detect the signal b′ which should be originally output, or outputs a signal weaker than the signal b. When the object OBJ is located at the angle of view α, the light-receiving element 52 does not output the signal a′ that should be originally output, or outputs a signal weaker than the signal a.

The light-receiving element 52 outputs a signal SR based on the illumination light from the light source unit 10 regardless of the guaranteed temperature. That is, outside the guaranteed temperature, the signal at any angle of view becomes small or is not detected, but the signal SR based on the illumination light from the light source unit 10 is always output.

This embodiment can determine whether or not the illumination light is emitted from the light source unit 10, using the detector 50 different from the detector 40, and thus can more reliably determine whether or not the wavelength band of the illumination light from the light source unit 10 has deviated from the transmission wavelength band of the path filter 41. Thus, the signal SG is configured to be output at a specific angle of view, and the signal SR based on the illumination light is output separately from the signal SG without depending on the temperature. Thereby, the reliability of the signal SG itself can be improved based on the intensity changes of the signals SG and SR. As a result, the reliability of the signal based on the reflected light from the object OBJ output at an angle of view other than the specific angle of view is determined based on the presence and absence of the signal SG, the intensity change, the intensity ratio, and the like. This configuration can avoid an erroneous determination on the signal based on the reflected light from the object OBJ.

The signal SR can be output even if the light guide 20 has a flat plate shape. This embodiment provides the reflector 71 to the window 70, but may provide it to the magnification varying optical system 60.

### In-Vehicle System

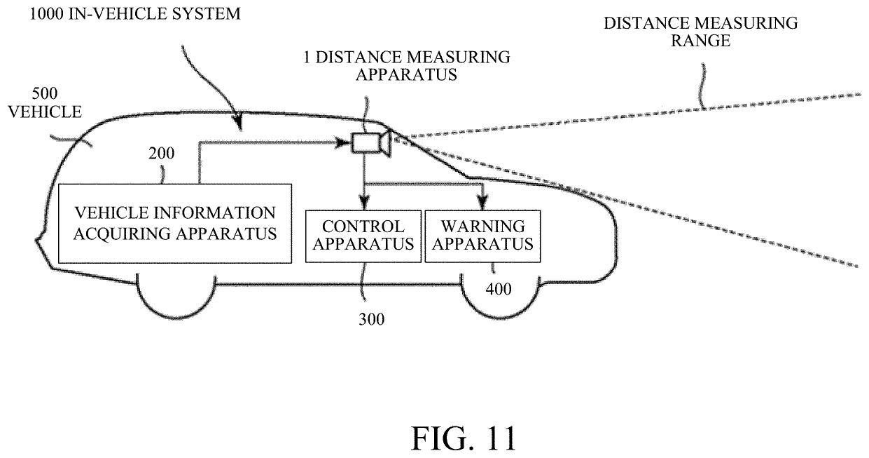

FIG. 10 is a configuration diagram of the optical apparatus 1 according to this embodiment and an in-vehicle system (driving supporting apparatus) 1000 including the optical apparatus 1. The in-vehicle system 1000 is an apparatus held by a movable device (mobile apparatus) such as an automobile (vehicle) and configured to support driving (maneuvering) of a vehicle based on distance information of an object such as an obstacle or a pedestrian around the vehicle acquired by the optical apparatus 1. FIG. 11 is a schematic view of a vehicle 500 including the in-vehicle system 1000. Although FIG. 11 illustrates a distance measuring range (detecting range) of the optical apparatus 1 set to the front side of the vehicle 500, the distance measuring range may be set to the rear or side of the vehicle 500.

As illustrated in FIG. 10, the in-vehicle system 1000 includes the optical apparatus 1, a vehicle information acquiring apparatus 200, a control apparatus (ECU: electronic control unit) 300, and a warning apparatus (warner) 400. In the in-vehicle system 1000, the controller 100 included in the optical apparatus 1 serves as a distance acquirer and a collision determiner. However, if necessary, the in-vehicle system 1000 may be provided with a distance acquirer and a collision determiner that are separate from the controller 100, and each component may be provided outside the optical apparatus 1 (for example, inside the vehicle 500). Alternatively, the control apparatus 300 may be used as the controller 100.

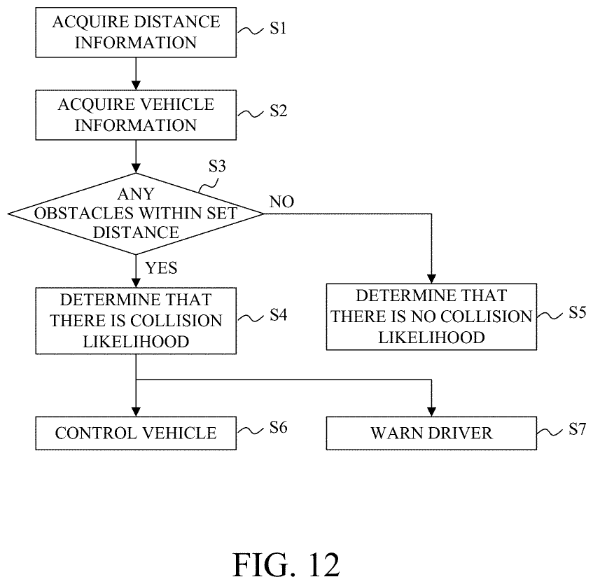

FIG. 12 is a flowchart showing an operation example of the in-vehicle system 1000 according to this embodiment. Referring now to this flowchart, a description will be given of the operation of the in-vehicle system 1000.

First, in the step S1, the light source unit 10 of the optical apparatus 1 illuminates an object around the vehicle, and the controller 100 acquires the distance information to the object OBJ based on the signal output from the light-receiving element 43 by receiving the reflected light from the object. In the step S2, the vehicle information acquiring apparatus 200 acquires vehicle information including a vehicle speed, a yaw rate, a steering angle, and the like. Then, in the step S3, the controller 100 determines whether or not the distance to the object OBJ is included in the preset distance range, using the distance information acquired in the step S1 and the vehicle information acquired in the step S2.

This configuration can determine whether or not the object exists within the set distance around the vehicle, and a collision likelihood between the vehicle and the object. The steps S1 and S2 may be performed in the reverse order or in parallel. The controller 100 determines that there is the collision likelihood when the object exists within the set distance (step S4), and that there is no collision likelihood when the object does not exist within the set distance (step S5).

Next, when the controller 100 determines that there is the collision likelihood, the controller 100 notifies (transmits) the determination result to the control apparatus 300 and the warning apparatus 400. At this time, the control apparatus 300 controls the vehicle based on the determination result of the controller 100 (step S6), and the warning apparatus 400 warns the user (driver) of the vehicle based on the determination result of the controller 100 (step S7). The determination result may be notified to at least one of the control apparatus 300 and the warning apparatus 400.

The control apparatus 300 can control moving of the vehicle by outputting a control signal to the driving unit (engine, motor, etc.) of the vehicle. For example, the vehicle provides a control such as braking, releasing the accelerator, turning the steering wheel, and generating a control signal for generating a braking force on each wheel to suppress the output of the engine or the motor. The warning apparatus 400 warns the driver, for example, by emitting a warning sound, by displaying warning information on the screen of a car navigation system, or by vibrating the seat belt or steering wheel.

Thus, the in-vehicle system 1000 according to this embodiment can detect the object and measure the distance to the object using the above processing, and prevent the collision between the vehicle and the object. In particular, applying the optical apparatus 1 according to each of the above embodiments to the in-vehicle system 1000 can realize high distance measuring accuracy, so that object detection and collision determination can be performed with high accuracy.

While this embodiment applies the in-vehicle system 1000 to driving support (collision damage mitigation), but the present invention is not limited to this example, and the in-vehicle system 1000 is applicable to cruise control (including with all vehicle speed tracking function) and automatic driving. The in-vehicle system 1000 is applicable not only to a vehicle such as an automobile but also to a mobile device such as a ship, an aircraft, or an industrial robot. It is also applicable not only to the mobile device but also to various devices using object recognition such as an intelligent transportation system (ITS) and a monitoring system.

The in-vehicle system 1000 and the mobile apparatus may include a notification apparatus (notifier) configured to notify a manufacturer of the in-vehicle system and a seller (dealer) of the mobile apparatus of the fact that the mobile apparatus collides with an obstacle. For example, the notification apparatus may transmit information (collision information) on a collision between the mobile apparatus and the obstacle to a preset external notification destination by e-mail or the like.

Thus, a configuration in which the notification apparatus automatically notifies the collision information can promptly take post-collision measures such as an inspection and a repair. The notification destination of the collision information may be an insurance company, a medical institution, the police, or an arbitrary destination which the user previously sets. The notification apparatus may notify the notification destination of not only the collision information but also the failure information of each component and consumption status information of consumables. The presence or absence of a collision may be detected based on the distance information acquired with the output from the light receiver as described above, or another detector (sensor).

The above embodiments can provide an optical apparatus, an in-vehicle system, and a mobile apparatus, each of which can determine the reliability of the signal based on the reflected light from the object.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-086574, filed on May 18, 2020, which is hereby incorporated by reference herein in its entirety.

What is claimed is:

1. An optical apparatus comprising:
a deflector configured to deflect illumination light from a light source unit to scan an object, and configured to deflect reflected light from the object;
a light guide configured to guide the illumination light from the light source unit to the deflector, and configured to guide reflected light from the deflector to a first light-receiving element;
a reflector configured to reflect first light that is part of the illumination light from the deflector, and to reintroduce the first light to the deflector;
a filter disposed between the reflector and the first light-receiving element, and configured to transmit light in a specific wavelength band; and
a controller configured to determine whether an intensity of the first light is included in a specific numerical range by using a signal output from the first light-receiving element corresponding to the first light.

2. The optical apparatus according to claim 1, wherein the light guide guides one part of the illumination light from the light source unit to the deflector and another part to a second light-receiving element.

3. The optical apparatus according to claim 2, wherein the controller determines a reliability of a signal based on the reflected light from the object, using the signal output from the first light-receiving element and a signal output from the second light-receiving element.

4. The optical apparatus according to claim 1, wherein the controller determines whether or not the intensity of the first light is included in the specific numerical range from when the light source unit emits the illumination light to when the first light-receiving element receives the reflected light from the object.

5. The optical apparatus according to claim 1, wherein the light guide transmits one part of the illumination light, reflects another part of the illumination light, and reflects the reflected light from the deflector.

6. The optical apparatus according to claim 1, wherein the light guide includes an optical element having a plurality of optical surfaces that are not parallel to each other.

7. The optical apparatus according to claim 1, further comprising an optical system configured to guide the illumination light from the deflector to the object and to guide the reflected light from the object to the deflector.

8. The optical apparatus according to claim 7, wherein the optical system is a magnification varying optical system.

9. The optical apparatus according to claim 7, wherein the optical system has no refractive power as a whole.

10. The optical apparatus according to claim 7, wherein on a deflection surface of the deflector, an incident point of a principal ray of the illumination light and an optical axis of the optical system are separated from each other.

11. The optical apparatus according to claim 1, wherein the controller determines a reliability of a signal based on the reflected light from the object, using a determination result of whether or not the intensity of the first light is included in the specific numerical range.

12. An in-vehicle system comprising the optical apparatus according to claim 1, wherein the in-vehicle system determines a collision likelihood between a vehicle and the object based on distance information of the object acquired by the optical apparatus.

13. The in-vehicle system according to claim 12, further comprising a control apparatus configured to output a control signal that generates a braking force in the vehicle when determining that there is the collision likelihood between the vehicle and the object.

14. The in-vehicle system according to claim 12, further comprising a warning apparatus configured to warn a driver of the vehicle when it is determined that there is the collision likelihood between the vehicle and the object.

15. The in-vehicle system according to claim 12, further comprising a notification apparatus configured to notify information on a collision between the vehicle and the object.

16. A mobile apparatus comprising the optical apparatus according to claim 1, wherein the mobile apparatus is movable while holding the optical apparatus.

17. The mobile apparatus according to claim 16, further comprising a determiner configured to determine a collision likelihood with the object based on distance information of the object acquired by the optical apparatus.

18. The mobile apparatus according to claim 17, further comprising a second controller configured to output a control signal to control a movement when determining that there is the collision likelihood with the object.

19. The mobile apparatus according to claim 17, further comprising a warner configured to warn a driver of the mobile apparatus when it is determined that there is the collision likelihood with the object.

20. The mobile apparatus according to claim 16, further comprising a notifier configured to notify information on a collision with the object.
